(19) United States
(12) Patent Application Publication
(10) Pub. No.: US 2011/0080445 A1
(43) Pub. Date: Apr. 7, 2011

(54) LIQUID EJECTING APPARATUS

(75) Inventors: Kazutoshi SHIMIZU, Shimosuwa-mati (JP); Toshio KUMAGAI, Shiojiri-shi (JP)

(73) Assignee: SEIKO EPSON CORPORATION, Tokyo (JP)

(21) Appl. No.: 12/897,909

(22) Filed: Oct. 5, 2010

(30) Foreign Application Priority Data
Oct. 6, 2009 (JP) 2009-232583

(51) Int. Cl. B41J 2/165

(52) U.S. Cl. 347/31; 347/33

(57) ABSTRACT

A liquid ejecting apparatus includes a liquid ejecting head that has a nozzle forming surface on which nozzles for ejecting liquid are opened and which is provided so as to be inclined, a cleaning unit that executes a cleaning process of discharging liquid through the nozzles on the nozzle forming surface, and an absorbing member that is capable of absorbing the liquid and is arranged on a side position of the liquid ejecting head which is lower in the gravity direction in a direction of inclination of the nozzle forming surface.

### BACKGROUND

1. Technical Field

The present invention relates to a liquid ejecting apparatus such as an ink jet printer.

2. Related Art

An ink jet printer in which ink is ejected onto a recording medium such as a recording sheet through nozzles opened on a nozzle forming surface of a recording head to perform printing has been well known as a type of liquid ejecting apparatuses in the past. As a printer of this type, a printer in which a nozzle forming surface is provided so as to be in parallel with the horizontal direction is common. However, a printer in which such nozzle forming surface is provided so as to be inclined with respect to the horizontal direction at a predetermined angle has also been known (for example, JP-A-2008-296595).

In general, the following problem arises in such a printer. That is, clogging of nozzles is caused because liquid contents and volatile components of ink accumulated in the nozzles evaporate to increase the viscosity of ink, or foreign matters such as bubbles, metal particles, or the like get in the nozzles in some case. Further, if such clogging or entry of foreign matters happens in the nozzles, a print failure occurs. For example, a discharge direction of ink is deviated, or an appropriate amount of ink cannot be discharged through the nozzles. As a countermeasure for the above problem, in such ink jet printer, a cleaning process is periodically performed while a printing process is not executed in order to eliminate the nozzle clogging and discharge foreign matters and the like gotten in the nozzles. As the cleaning process, a vacuum cleaning process and a pressure cleaning process are exemplified.

For example, when the vacuum cleaning process is performed, a cap and a nozzle forming surface are relatively moved so as to be opposed to each other, first. Then, the cap is moved and is made to abut against the nozzle forming surface so as to enclose the nozzles. With this, an enclosed space in which the nozzles communicate with an inner portion of the nozzles is formed between an inner surface of the cap and the nozzle forming surface. Then, a suction pump connected to the cap is driven so that ink of which viscosity has been increased in the nozzles causing clogging is sucked and discharged through the enclosed space in the cap. Then, when the suction operation by the suction pump is finished, ink is swept off the nozzle forming surface by separating the cap from the nozzle forming surface and sliding a wiper along the nozzle forming surface. On the other hand, when the pressure cleaning process is performed, ink in ink cartridges is pressurized so as to be forcibly discharged through the nozzles onto the nozzle forming surface in a flushing manner. Thereafter, ink is swept off the nozzle forming surface by sliding a wiper on the nozzle forming surface as in the case of the vacuum cleaning process.

In the printer as described in JP-A-2008-296595 in which a nozzle forming surface is inclined with respect to the horizontal direction at a predetermined angle, if the cleaning process as described above is performed, ink forcibly discharged through nozzles may adhere to the nozzle forming surface. Further, ink adhered to the nozzle forming surface in such a manner flows down the nozzle forming surface before the ink is swept by a wiper or during the sweep by the wiper. This poses a risk that the ink may happen to soil portions positioned below the nozzle forming surface.

In general, such problem is commonly caused not only in the ink jet printer as described above but also in other liquid ejecting apparatuses. The other liquid ejecting apparatuses include printing apparatuses used in a facsimile machine, a copying machine, or the like, liquid ejecting apparatuses which eject liquid such as an electrode material or a color material used for manufacturing a liquid crystal display, an EL display, a surface emitting display, or the like.

### SUMMARY

An advantage of some aspects of the invention is to provide a liquid ejecting apparatus employing a technique of suppressing a problem that liquid flows down a nozzle forming surface and soils portions positioned below the nozzle forming surface when a cleaning process is performed in the liquid ejecting apparatus having a liquid ejecting head of which nozzle forming surface is inclined with respect to the horizontal direction.

A liquid ejecting apparatus according to an aspect of the invention includes a liquid ejecting head that has a nozzle forming surface on which nozzles for ejecting liquid are opened and which is provided so as to be inclined, a cleaning unit that executes a cleaning process for discharging liquid through the nozzles on the nozzle forming surface, and an absorbing member that is capable of absorbing the liquid and is arranged on a side position of the liquid ejecting head which is lower in the gravity direction in a direction of inclination of the nozzle forming surface.

With the aspect of the invention, the absorbing member which absorbs liquid is arranged on a side position of the liquid ejecting head which is lower in the gravity direction in a direction of inclination of the nozzle forming surface. Therefore, even if liquid discharged through the nozzles during the cleaning process flows down the nozzle forming surface, the liquid is absorbed by the absorbing member. Accordingly, in the liquid ejecting apparatus having a liquid ejecting head in which the nozzle forming surface is inclined, the following problem can be suppressed. That is, the problem that when the cleaning process of the nozzles is executed, liquid flows down the nozzle forming surface and soils portions positioned below the nozzle forming surface can be suppressed.

In the liquid ejecting apparatus according to the aspect of the invention, it is preferable that the cleaning unit include a wiper which sweeps the liquid off the nozzle forming surface by making contact with the nozzle forming surface, and the wiper be capable of abutting against the absorbing member in a state where the liquid is adhered to the wiper.

With the aspect of the invention, when the cleaning process is executed, the wiper makes contact with the nozzle forming surface so as to sweep liquid off the nozzle forming surface. Then, when the wiper abuts against the absorbing member in a state where liquid is adhered to the wiper, liquid adhered to the wiper is absorbed by the absorbing member and removed from the wiper. Accordingly, the absorbing member has a function of suppressing a problem that liquid flows down the nozzle forming surface and soils portions positioned below the nozzle forming surface when the cleaning process is executed, and a function of absorbing and removing liquid adhered to the wiper. With this, a configuration of the liquid ejecting apparatus can be simplified in comparison with a case where each of these functions is assigned to a separate member.

In the liquid ejecting apparatus according to the aspect of the invention, it is preferable that the wiper be capable of sliding on the nozzle forming surface from an upper side position to a lower side position in the direction along the nozzle forming surface and abutting against the absorbing member in a state where the wiper is in contact with the nozzle forming surface.

With the aspect of the invention, the wiper abuts against the absorbing member at a stage before the wiper is separated from the nozzle forming surface. Therefore, liquid adhered to a surface of the wiper can be suppressed from scattering around.

In the liquid ejecting apparatus according to the aspect of the invention, it is preferable that the wiper be formed with an elastic member having flexibility, and an abutment surface of the absorbing member against which the wiper abuts have a shape that follows a surface of the wiper at the side of the absorbing member, which is obtained when the wiper slides on the nozzle forming surface and bends.

With the aspect of the invention, when the absorbing member abuts against the wiper, the absorbing member and the wiper are contacted to each other more tightly with an increased contact area. Accordingly, liquid adhered to the wiper by the sweep along the nozzle forming surface can be absorbed by the absorbing member and removed more effectively.

In the liquid ejecting apparatus according to the aspect of the invention, it is preferable that the liquid ejecting apparatus further include a driving mechanism which relatively displaces at least one of the absorbing member and the wiper such that the absorbing member slides along a surface of the wiper to which the liquid is adhered in a state where the absorbing member abuts against the surface of the wiper.

With the aspect of the invention, even when liquid adhered to a surface of the wiper is not completely absorbed only by making the surface of the wiper to which liquid is adhered abut against the absorbing member and is left on the surface of the wiper, the liquid can be absorbed and removed from the surface of the wiper reliably by sliding the absorbing member along the surface of the wiper.

In the liquid ejecting apparatus according to the aspect of the invention, it is preferable that the absorbing member be arranged to be in contact with the liquid ejecting head so as not to generate a space between the absorbing member and the nozzle forming surface.

With the aspect of the invention, even when liquid discharged during the cleaning process flows down the nozzle forming surface, a problem that the flown liquid flows down a space between the absorbing member and the nozzle forming surface and soils portions positioned below the nozzle forming surface can be suppressed more effectively.

In the liquid ejecting apparatus according to the aspect of the invention, it is preferable that the liquid ejecting apparatus further include a suction unit which sucks liquid absorbed by the absorbing member by applying a negative pressure to the absorbing member.

With the aspect of the invention, liquid absorbed by the absorbing member is sucked and discharged with a negative pressure applied to the absorbing member. Therefore, liquid absorption ability of the absorbing member can be kept. In addition, liquid absorbed and captured by the absorbing member can be suppressed from flowing outside again.

### BRIEF DESCRIPTION OF THE DRAWINGS

The invention will be described with reference to the accompanying drawings, wherein like numbers reference like elements.

FIG. 1 is a plan view schematically illustrating an ink jet printer according to a first embodiment.

FIG. 2 is a partial enlarged cross-sectional view illustrating a liquid ejecting head and a cleaner mechanism according to the first embodiment.

FIGS. 3A through 3C are partial enlarged cross-sectional views illustrating a driving mode of a wiper.

FIGS. 4A and 4B are partial enlarged cross-sectional views illustrating a driving mode of a cleaner mechanism.

FIG. 5 is a partial enlarged cross-sectional view illustrating the liquid ejecting head, the wiper and the cleaner mechanism.

FIG. 6 is a partial enlarged cross-sectional view illustrating a liquid ejecting head, a cap and a cleaner mechanism according to a second embodiment.

### DESCRIPTION OF EXEMPLARY EMBODIMENTS

### First Embodiment

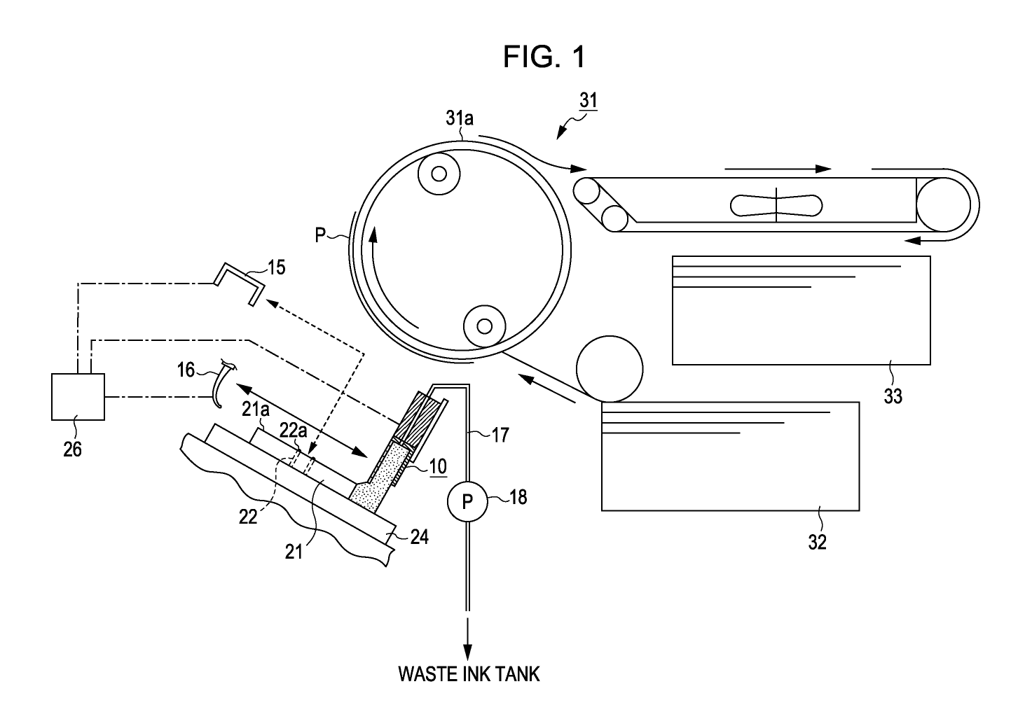

Hereinafter, a first embodiment in which a liquid ejecting apparatus according to the invention is embodied as an ink jet printer using ink as liquid will be described with reference to FIG. 1 through FIG. 5. FIG. 1 is a plan view schematically illustrating an ink jet printer according to the first embodiment. In FIG. 1, a head substrate 24, a recording head 21, a wiper 16, a cap 15, and a cleaner mechanism 10 which will be described later are illustrated in a partially enlarged manner.

As shown in FIG. 1, an ink jet printer has a transportation apparatus 31 having a rotational drum 31a, and the recording head 21 as a liquid ejecting head, which is arranged below the transportation apparatus 31 and ejects ink onto a sheet P. The rotational drum 31a of the transportation apparatus 31 transports the sheet P by winding the sheet P therearound at the time of printing. The rotational drum 31a of the transportation apparatus 31 is driven by a motor or the like so as to rotate at a constant speed in the direction as shown by an arrow in FIG. 1. A sheet feeding tray 32 and a sheet discharge tray 33 are arranged in the vicinity of the transportation apparatus 31. The sheet feeding tray 32 accommodates the sheet P to be printed on and the sheet discharge tray 33 accommodates the printed sheet P.

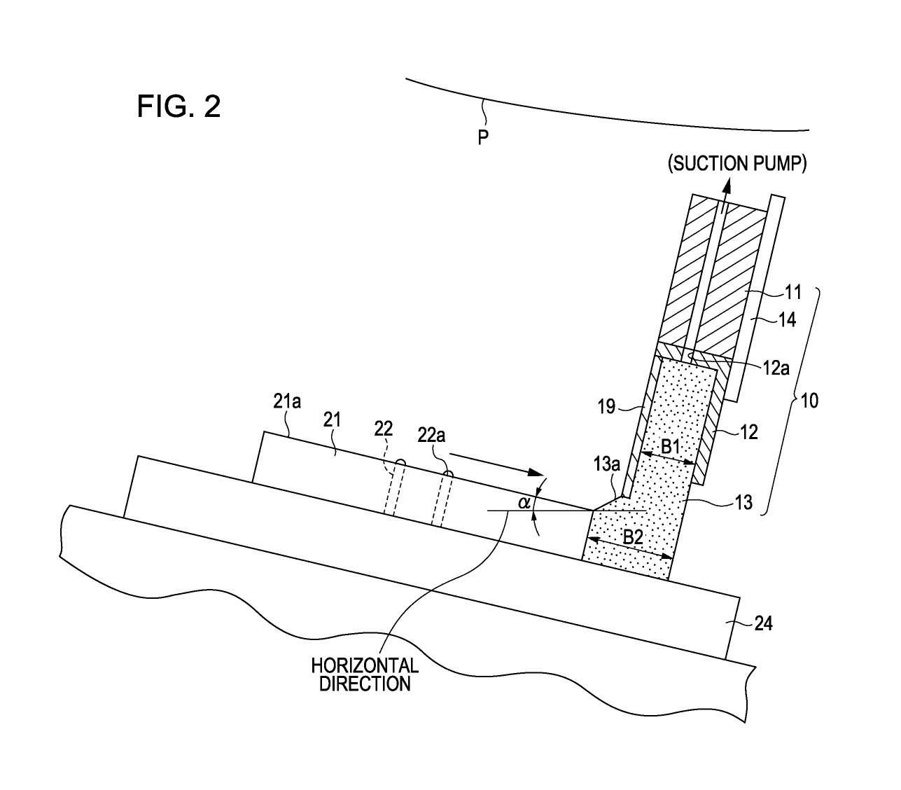

As shown in FIG. 1 and FIG. 2, the recording head 21 is arranged on the head substrate 24 and is a recording head of a so-called full-line type. The recording head 21 of such type has a head length corresponding to a length in the width direction of the sheet P (direction perpendicular to a paper surface of FIGS. 1 and 2) which is perpendicular to the transportation direction of the sheet P (direction shown by arrows in FIG. 1). A plurality of nozzles 22 are formed on the recording head 21. A plurality of nozzles 22 having openings 22a on a surface (nozzle forming surface 21a) opposed to an outer circumferential surface of the rotational drum 31a are formed. A plurality of ink cartridges (not shown) for storing different inks are detachably mounted to the head substrate 24. Ink stored in each of the ink cartridges is supplied to the recording head 21 during printing. At this time, ink is supplied in a state where a pressure thereof is adjusted to a predetermined pressure depending on data to be printed. Ink supplied to the recording head 21 in such a manner is pressurized by a piezoelectric device (not shown) and discharged toward the sheet P through the openings 22a of the nozzles 22. Further, the recording head 21 is arranged on the head substrate 24 (see, FIG. 2) in a state where the nozzle forming surface 21a is inclined with respect to the horizontal direction such that ink is perpendicularly discharged through the nozzles 22 onto the sheet P positioned on an outer circumferential surface of the rotational drum 31a. To be more specific, the recording head 21 is arranged on the head substrate 24 in a state where the nozzle forming surface 21a is inclined at a predetermined angle α. Therefore, ink is discharged obliquely upward to the sheet P with respect to the horizontal direction through the openings 22a of the nozzles 22.

Further, as shown in FIG. 1, the wiper 16, the cap 15 and the cleaner mechanism 10 are provided in the vicinity of the recording head 21. To be more specific, the wiper 16 is arranged on an upper side in the direction of inclination of the nozzle forming surface 21a (direction shown by a solid arrow in FIG. 1). On the other hand, the cleaner mechanism 10 is arranged on a lower side in the direction of inclination of the nozzle forming surface 21a.

The wiper 16 is formed with an elastic material (for example, natural rubber or synthetic rubber) into a stripe form. A base end of the wiper 16 is supported by a supporting member (not shown). Further, the cap 15 has a box-shape with a bottom at one side. A lower side of the cap 15 in the direction perpendicular to the nozzle forming surface 21a is opened. At least an opening frame portion of the cap 15 is formed with an elastic member as in the case of the wiper 16. Then, when the printer is in the power-OFF state, the cap 15 abuts against the nozzle forming surface 21a such that a squarely looped opening frame portion of the cap 15 encloses the openings 22a of the nozzles 22. With this, a sealed moisture space is formed between the nozzle forming surface 21a and an inner surface of the cap 15 so as to suppress the ink in the nozzles 22 from increasing in viscosity and from drying.

Further, as shown in FIG. 2, the cleaner mechanism 10 includes a metal tube 11, a holding member 12, an absorbing member 13, and a leaf spring 14.

The absorbing member 13 is formed with felt and can absorb and hold ink. An upper portion of the absorbing member 13 is pressed into a gutter-shaped holding member 12. A side face of the gutter-shaped holding member 12 at the side of the nozzle forming surface 21a is sealed with a film 19 in a state where the holding member 12 allows the upper portion of the absorbing member 13 to be pressed into the holding member 12. On the other hand, a lower portion of the absorbing member 13 is not covered with the holding member 12 or the film 19 so as to be exposed. Further, a width (B1) of the upper portion of the absorbing member 13 along the direction of inclination of the nozzle forming surface 21a is smaller than a width (B2) of the lower portion thereof along the direction of inclination.

The exposed lower portion of the absorbing member 13 is biased toward the side of the recording head 21 with the leaf spring 14. Therefore, the exposed lower portion is in contact with a side face of the recording head 21 at the lower side so as not to generate a space between the exposed lower portion of the absorbing member 13 and a lower edge of the nozzle forming surface 21a at the lower side in the direction of inclination thereof. That is to say, the absorbing member 13 is arranged on a side position of the recording head 21 at a lower side in the direction of inclination of the nozzle forming surface 21a. Further, a side face of the exposed lower portion of the absorbing member 13 at the side of the nozzle forming surface 21a corresponds to an inclined surface 13a obliquely extending from a site corresponding to the lower edge of the film 19 to a contact site with the lower edge of the nozzle forming surface 21a.

The metal tube 11 is formed with a metal material such as stainless steel, which is excellent in corrosion resistance, and is fixed to an upper surface of the holding member 12. A communication hole 12a is formed on an upper portion of the holding member 12 and the metal tube 11 is connected to the communication hole 12a at the lower edge of the metal tube 11. As shown in FIG. 1, the metal tube 11 is connected to a suction pump 18 through a negative pressure path 17. Then, a negative pressure can be applied to the absorbing member 13 through the negative pressure path 17, the metal tube 11, and the communication hole 12a by a suction operation of the suction pump 18.

As shown in FIG. 1, a driving mechanism 26 which drives the wiper 16, the cap 15, and the cleaner mechanism 10 is provided on the printer. The wiper 16, the cap 15, and the cleaner mechanism 10 are driven by the driving mechanism 26 so as to move along predetermined paths, respectively. That is, the wiper 16 reciprocates along a path shown by a solid line arrow between an original position as shown in FIG. 1 and a position where the wiper 16 abuts against the absorbing member 13. On the other hand, the cap 15 reciprocates along a path shown by a dashed-line arrow between an original position as shown in FIG. 1 and a position where the lower opening frame portion of the cap 15 is tightly adhered to the nozzle forming surface 21a. Further, the cleaner mechanism 10 reciprocates along the direction perpendicular to the nozzle forming surface 21a between an original position where the absorbing member 13 is in contact with the side portion of the recording head 21 as shown in FIG. 1 and a position where the absorbing member 13 is separated upward from the recording head 21.

Next, a cleaning process (pressure cleaning process in the embodiment) of the recording head 21 is described below. In this process, ink in the ink cartridges is pressurized, first. Then, ink is pressure-supplied to the side of the recording head 21 from the ink cartridges. Further, ink of which viscosity has been increased, foreign matters, and the like in the nozzles 22 are forcibly discharged onto the nozzle forming surface 21a through the openings 22a of the nozzles 22 in the recording head 21 in a flushing manner. As a result, ink droplets grow up on the nozzle forming surface 21a of the recording head 21 so as to cover the openings 22a of the nozzles 22.

If viscosity of ink is increased or ink is dried to be solidified in a state where the grown-up ink droplets cover the openings 22a of the nozzles 22 as described above, ink is not smoothly ejected through the openings 22a of the nozzles 22. Therefore, when ink droplets grow up on the nozzle forming surface 21a by the pressure cleaning process, a sweep cleaning is executed for the nozzle forming surface 21a with the wiper 16 in order to sweep the ink.

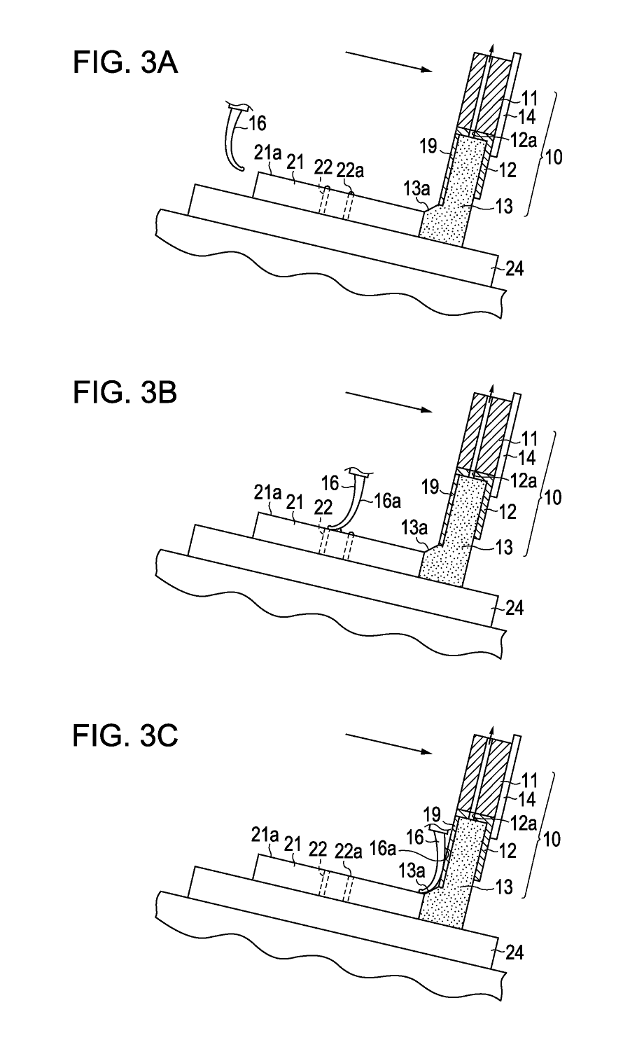

That is to say, the wiper 16 slides on the nozzle forming surface 21a from a position shown in FIG. 3A along the direction shown by arrows in FIGS. 3B and 3C based on the driving of the driving mechanism 26. To be more specific, the wiper 16 slides from one (upper side) end of the nozzle forming surface 21a to the other (lower side) end thereof on the nozzle forming surface 21a. With this, ink adhered to the nozzle forming surface 21a is swept and cleaned. At this time, the wiper 16 is made to be in pressure contact with the nozzle forming surface 21a as shown in FIG. 3B, thereby sliding on the nozzle forming surface 21a in a bending manner.

Then, as shown in FIG. 3C, when the wiper 16 slides to the lower edge of the nozzle forming surface 21a at the lower side in the direction of inclination thereof, a liquid sweeping surface of the wiper 16 abuts against the absorbing member 13 of the cleaner mechanism 10. The liquid sweeping surface of the wiper 16 corresponds to an ink sweeping surface 16a to which ink swept off the nozzle forming surface 21a is adhered. At this time, the wiper 16 also abuts against the absorbing member 13 in a state where the wiper 16 is in contact with the nozzle forming surface 21a. That is to say, the wiper 16 also abuts against the absorbing member 13 at a stage before the wiper 16 is separated from the nozzle forming surface 21a. Therefore, the wiper 16 does not recover to an original shape from a bent shape resulting from sliding on the nozzle forming surface 21a. Accordingly, ink adhered to the wiper 16 never scatters around. Further, the ink sweeping surface 16a abuts against the absorbing member 13 in such a manner so that ink adhered to the ink sweeping surface 16a is absorbed by the absorbing member 13 and removed.

At this time, the absorbing member 13 has a shape such that a side face of the absorbing member 13 at the side of the recording head 21 is inclined from a lower edge of the film 19 toward a lower edge of the nozzle forming surface 21a at the lower side in the direction of inclination thereof. That is to say, the inclined surface 13a of the absorbing member 13 has a shape such that the inclined surface 13a follows the ink sweeping surface 16a when the wiper 16 is made to be in pressure contact with the nozzle forming surface 21a and bends. Therefore, an area of an abutment portion obtained when the absorbing member 13 abuts against the ink sweeping surface 16a is increased so that the surface of the absorbing member 13 and the ink sweeping surface 16a are adhered to each other more tightly. Accordingly, ink adhered to the ink sweeping surface 16a is effectively absorbed by the absorbing member 13 and removed.

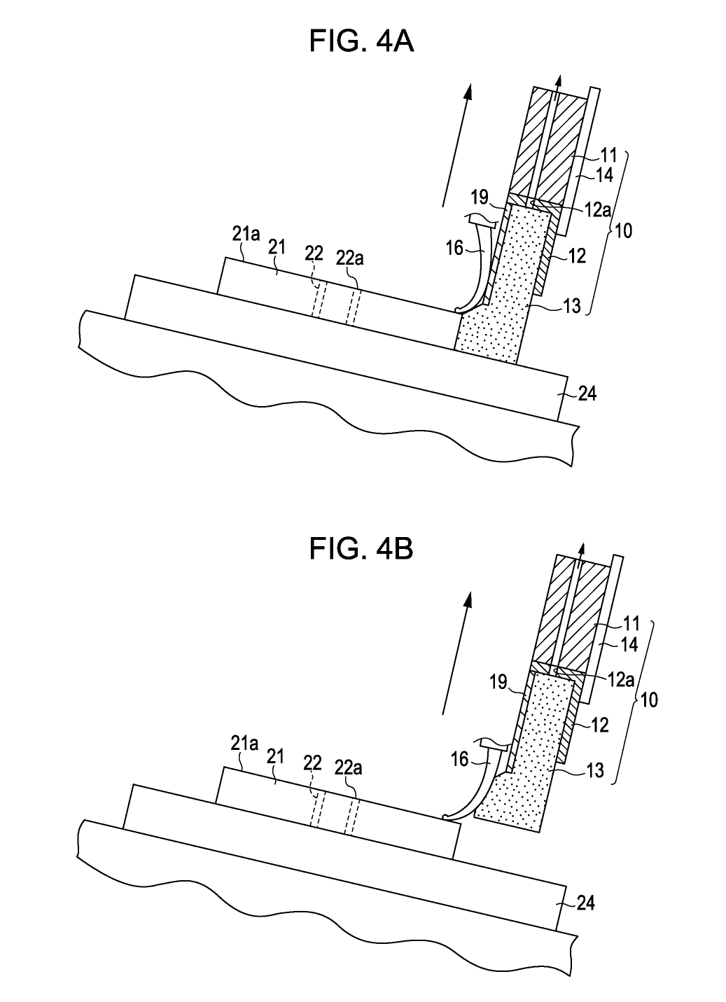

Then, after the ink sweeping surface 16a of the wiper 16 abuts against the absorbing member 13 as shown in FIG. 4A, the cleaner mechanism 10 moves upward in the direction perpendicular to the nozzle forming surface 21a based on the driving of the driving mechanism 26 as shown in FIG. 4B. As a result, the absorbing member 13 sweeps ink on the ink sweeping surface 16a while sliding along the ink sweeping surface 16a of the wiper 16. In this case, the absorbing member 13 is biased to the side of the ink sweeping surface 16a with the leaf spring 14. Therefore, a contact pressure between the ink sweeping surface 16a and the absorbing member 13 can be increased so that ink on the ink sweeping surface 16a can be swept with the absorbing member 13 more effectively. Accordingly, even if ink is left on the ink sweeping surface 16a when the wiper 16 abuts against the absorbing member 13, the ink can be swept and removed reliably.

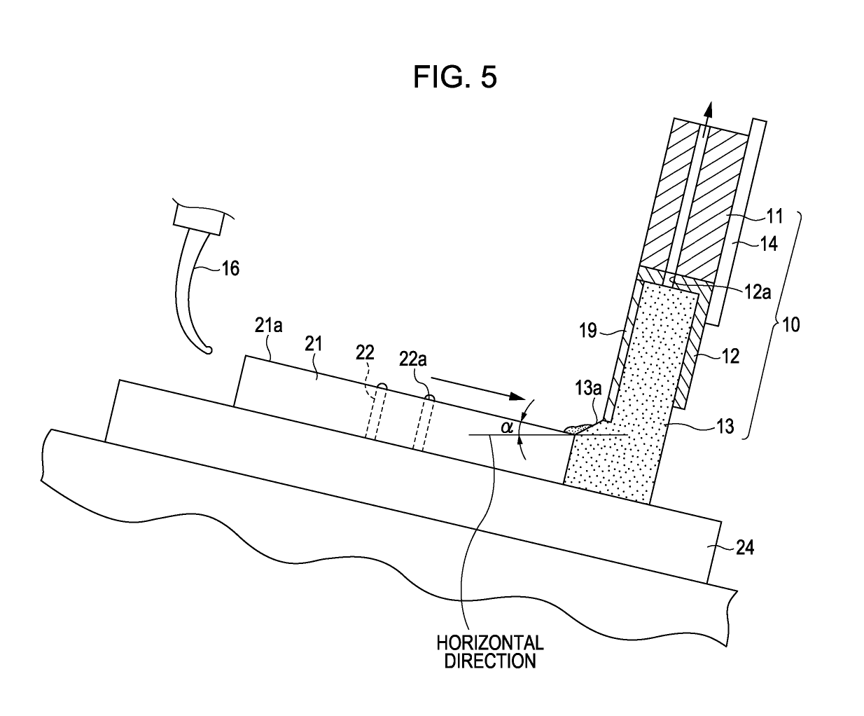

Incidentally, as shown in FIG. 5, the nozzle forming surface 21a is inclined with respect to the horizontal direction at the predetermined angle α. Therefore, ink on the nozzle forming surface 21a flows down the nozzle forming surface 21a before the ink is swept by the wiper 16 or during the sweep cleaning by the wiper 16 due to an action of gravity in some case. Ink thus flown down the nozzle forming surface 21a is absorbed by the absorbing member 13 (in particular, at a lower portion thereof) which is arranged on a side position of the recording head 21 at a lower side with respect to the gravity direction in the direction along the nozzle forming surface 21a. Further, as described above, the lower portion of the absorbing member 13 is biased with the leaf spring 14. Therefore, the lower portion of the absorbing member 13 is in contact with a side face of the recording head 21 so as not to generate a space between the lower portion of the absorbing member 13 and a lower edge of the nozzle forming surface 21a at a lower side in the direction of inclination thereof.

Therefore, a following problem can be suppressed. That is, a problem that ink flown down the nozzle forming surface 21a flows down a space between the absorbing member 13 and the nozzle forming surface 21a, and soils portions positioned below the nozzle forming surface 21a can be suppressed. It is to be noted that the portions positioned below the nozzle forming surface 21a correspond to an inner surface of various types of mechanisms and a bottom wall which are arranged below the nozzle forming surface 21a in the printer, or a surface of a placement table on which the printer is placed in a case where the printer does not have a bottom wall, for example. Thus, the absorbing member 13 has a function of suppressing a problem that ink flows down the nozzle forming surface 21a and soils portions positioned below the nozzle forming surface 21a, and a function of absorbing and removing ink adhered to the ink sweeping surface 16a of the wiper 16 as described above, that is, a function as a wiper cleaner.

Further, ink absorbed by the absorbing member 13 in such a manner is sucked by the suction pump 18 (see, FIG. 1) through the metal tube 11 and the like and discharged to a waste ink tank (not shown).

Further, a width B2 of the lower portion of the absorbing member 13 is larger than a width B1 of the upper portion thereof (see, FIG. 2) as described above. Therefore, a density (that is, a fiber density of felt) at the lower portion of the absorbing member 13 is lower than that at the upper portion thereof. Since a permeability of ink is increased at a portion where the density is low, a large amount of ink can be absorbed and held inside the portion. Therefore, when the lower portion of the absorbing member 13 abuts against the ink sweeping surface 16a, ink adhered to the ink sweeping surface 16a can be effectively absorbed. Then, some of ink absorbed by the lower portion of the absorbing member 13 permeates into the upper portion of the absorbing member 13. On the other hand, since the upper portion of the absorbing member 13 has a high fiber density of felt, a negative pressure easily acts on the upper portion. Accordingly, ink permeated into the upper portion of the absorbing member is sucked by the suction force of the suction pump 18 immediately.

Such action by the suction pump 18 suppresses the absorbing member 13 from becoming in a state where the absorbing member 13 absorbs too much ink. Further, ink absorption ability of the absorbing member 13 can be properly kept. In addition, ink absorbed and held by the absorbing member 13 can be suppressed from flowing outside again.

According to the embodiment, the following operation effects can be obtained.

(1) Since the absorbing member 13 which absorbs ink is arranged at a lower side in a direction of inclination of the nozzle forming surface 21a, even if ink forcibly discharged through the nozzles 22 during the cleaning process flows down the nozzle forming surface 21a, the ink is absorbed by the absorbing member 13. Accordingly, in an ink jet printer having the recording head 21 in which the nozzle forming surface 21a is arranged so as to be inclined with respect to the horizontal direction at the predetermined angle α, the following problem can be suppressed. That is, a problem that when the cleaning process of the nozzles 22 is executed, ink flows down the nozzle forming surface 21a and soils portions positioned below the nozzle forming surface 21a (a mechanism arranged below the nozzle forming surface 21a in the printer, for example) can be suppressed.

(2) When the cleaning process is executed, the wiper 16 makes contact with the nozzle forming surface 21a to sweep ink off the nozzle forming surface 21a. Then, when the wiper 16 abuts against the absorbing member 13 in a state where ink is adhered to the wiper 16, ink adhered to the wiper 16 is absorbed by the absorbing member 13 and removed from the wiper 16. Accordingly, the absorbing member 13 has a function of suppressing a problem that when the cleaning process is executed, ink flows down the nozzle forming surface 21a and soils portions positioned below the nozzle forming surface 21a, and a function of absorbing and removing ink adhered to the ink sweeping surface 16a of the wiper 16. With this, a configuration of the printer can be simplified in comparison with a case where each of these functions is assigned to a separate member.

(3) When the wiper 16 slides to the lower edge of the nozzle forming surface 21a at the lower side in the direction of inclination thereof during the cleaning process, the wiper 16 also abuts against the absorbing member 13 in a state where the wiper 16 is in contact with the nozzle forming surface 21a. Therefore, the wiper 16 does not recover to an original shape with an elastic force of the wiper 16, so that ink adhered to the ink sweeping surface 16a of the wiper 16 is suppressed from scattering around.

(4) An abutment surface (inclined surface 13a) of the absorbing member 13 against the wiper 16 has a shape that follows the ink sweeping surface (that is, surface of the wiper 16 at the side of the absorbing member 13) 16a obtained when the wiper 16 is made to be in pressure contact with the nozzle forming surface 21a and bends. Therefore, an area of an abutment portion obtained when the absorbing member 13 abuts against the ink sweeping surface 16a of the wiper 16 is increased, so that the surface of the absorbing member 13 and the ink sweeping surface 16a are contacted to each other more tightly. Accordingly, ink adhered to the ink sweeping surface 16a can be effectively absorbed by the absorbing member 13 and removed.

(5) The absorbing member 13 moves to the upper side of the nozzle forming surface 21a based on the driving of the driving mechanism 26 so that the absorbing member 13 slides along the ink sweeping surface 16a of the wiper 16. Therefore, even when ink is left on the ink sweeping surface 16a of the wiper 16, the ink can be swept and removed reliably when the absorbing member 13 slides along the ink sweeping surface 16a.

(6) Therefore, the lower portion of the absorbing member 13 is in contact with a side face of the recording head 21 so as not to generate a space between the lower portion of the absorbing member 13 and a lower edge of the nozzle forming surface 21a at a lower side in the direction of inclination thereof. Therefore, even when ink discharged during the cleaning process flows down the nozzle forming surface 21a, a problem that the flown ink flows down a space between the absorbing member 13 and the nozzle forming surface 21a and soils portions positioned below the nozzle forming surface 21a can be properly suppressed.

(7) Ink absorbed by the absorbing member 13 is sucked and discharged with a negative pressure applied through the suction pump 18. This makes it possible to suppress the absorbing member 13 from being in a state where the absorbing member 13 absorbs too much ink. Further, ink absorption ability of the absorbing member 13 can be properly kept. In addition, ink absorbed and held by the absorbing member 13 can be suppressed from being flowing outside again.

(8) The absorbing member 13 is biased to the side of the recording head 21 with the leaf spring 14 through the holding member 12. Therefore, a contact pressure between the absorbing member 13 and the recording head 21 can be increased so as to make the absorbing member 13 and the recording head 21 tightly contact each other. Accordingly, a space is not easily generated between the absorbing member 13 and the nozzle forming surface 21a, so that the printer can be suppressed from being soiled more properly.

(9) When the absorbing member 13 slides on the ink sweeping surface 16a of the wiper 16, the absorbing member 13 is biased to the side of the ink sweeping surface 16a with the leaf spring 14. Therefore, a contact pressure between the ink sweeping surface 16a and the absorbing member 13 can be increased. Accordingly, ink on the ink sweeping surface 16a can be swept and removed by the absorbing member 13 effectively.

### Second Embodiment

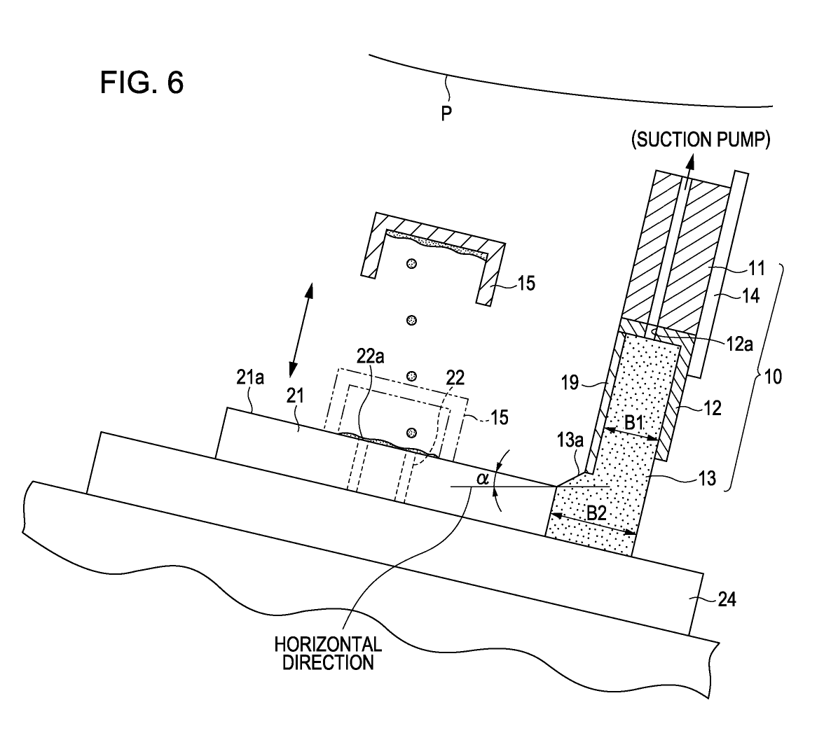

Next, a second embodiment of the invention will be described with reference to FIG. 6. It is to be noted that the second embodiment is different from the first embodiment in the following point. That is, in the second embodiment, the cleaning process of the recording head 21 is not the pressure cleaning process but a vacuum cleaning process. Configurations in other points in the second embodiment are the same as those in the first embodiment. Accordingly, the second embodiment is described focusing on different points from the first embodiment, hereinafter.

In the vacuum cleaning, the cleaner mechanism 10 is moved to a position where the lower portion of the absorbing member 13 is in contact with a side portion of the recording head 21 at a lower side in the direction along the nozzle forming surface 21a based on the driving of the driving mechanism 26, first. Next, the cap 15 is moved from an original position as shown in FIG. 1 to the side of the recording head 21 based on the driving of the driving mechanism 26. Then, an opening frame portion at the lower edge of the cap 15 is made to abut against the nozzle forming surface 21a of the recording head 21 so as to enclose the openings 22a of the nozzles 22. With this, the openings 22a on the nozzle forming surface 21a are covered by the cap 15 from an upper side, as shown in dashed-two dotted lines in FIG. 6.

Then, in this state, a suction pump (not shown) which is connected to the cap 15 through a suction tube (not shown) is driven. Then, a negative pressure is generated in the cap 15 so that ink of which viscosity has been increased, foreign matters, and the like in the nozzles 22 are forcibly sucked through the opening 22a of the nozzle 22 with the negative pressure and discharged onto the nozzle forming surface 21a. Thereafter, the cap 15 is moved upward as shown by a solid line in FIG. 6 based on the driving of the driving mechanism 26 in accompanied with the completion of suction operation. Then, the cap 15 and the nozzle forming surface 21a are made to be in a non-abutted state.

Then, during the vacuum cleaning process, the cap 15 is filled with ink of which viscosity has been increased in the nozzles 22. Therefore, a large amount of ink is adhered to a surface of the nozzle forming surface 21a at a region covered by the cap 15 or an inner circumferential surface of the cap 15. Further, as shown in FIG. 6, when the cap 15 moves to an upper side of the nozzle forming surface 21a, ink adhered to the inner circumferential surface of the cap 15 drops onto the nozzle forming surface 21a in some case. Therefore, after the vacuum cleaning process is finished, sweep cleaning of the nozzle forming surface 21a with the wiper 16 is executed in order to sweep ink left on the nozzle forming surface 21a in the same manner when the pressure cleaning process is finished.

As a result, as in the case of the first embodiment, ink is swept off the nozzle forming surface 21a with the wiper 16 and the ink adhered to the ink sweeping surface 16a of the wiper 16 at the time of sweep is absorbed by the absorbing member 13 and removed in the second embodiment. Further, the absorbing member 13 slides upward in a state where the lower portion of the absorbing member 13 is made to be in contact with the ink sweeping surface 16a of the wiper 16 so that ink is swept off the ink sweeping surface 16a of the wiper 16. Further, ink is sucked and discharged to the outside from the absorbing member 13 by the suction driving of the suction pump 18. Therefore, ink absorption ability of the absorbing member 13 can be properly kept. Accordingly, the same effects in the above items (1) through (9) in the first embodiment can be obtained in the second embodiment.

It is to be noted that each of the above embodiments can be also realized in the following modes.

In each of the above embodiments, the recording head 21 may have a configuration in which the nozzle forming surface 21a is inclined with respect to the horizontal direction at the predetermined angle and the nozzles 22 are provided so as to open to the downward direction with respect to the horizontal direction. In such an embodiment, with the absorbing member 13 which is arranged at the lower side in the direction along the nozzle forming surface 21a, the following problem can be suppressed. That is, the problem that ink left on and adhered to the nozzle forming surface 21a after the cleaning is finished flows down the nozzle forming surface 21a and soils portions positioned below the nozzle forming surface 21a can be suppressed.

In each of the above embodiments, the recording head 21 may have a configuration where only the nozzle forming surface 21a is inclined at the predetermined angle α. In this case, operation effects equivalent to those in each of the above embodiments can be obtained.

In the above embodiments, the recording head 21 may have a configuration where the nozzle forming surface 21a is arranged so as to be perpendicular to the horizontal direction (that is, so as to be along the vertical direction), for example. In such an embodiment, a problem that portions positioned below the nozzle forming surface 21a is soiled due to ink flown down the nozzle forming surface 21a in the vertical direction can be also suppressed.

In the above embodiments, the cleaner mechanism 10 may seal an upper portion of the absorbing member 13 with a cylindrical supporting member without using the film 19.

In the above embodiments, the wiper 16 may be configured so as to abut against the absorbing member 13 in a state where the wiper 16 is not in contact with the nozzle forming surface 21a when the wiper 16 slides to the lower edge of the nozzle forming surface 21a at the lower side in the direction of inclination thereof during the cleaning process. In such an embodiment, operation effects equivalent to the above items (1), (2), and (4) though (9) can be obtained.

In the above embodiments, the absorbing member 13 and the wiper cleaner may be formed as different members. In such an embodiment, operation effects equivalent to the above items (1), (3), (4), (5), (6), (7), (8) and (9) can be obtained.

In the above embodiments, in a so-called serial type printer, a configuration in which the recording head 21 and the cleaner mechanism 10 relatively move with respect to the wiper 16 which is fixedly arranged so that the wiper 16 sweeps ink off the nozzle forming surface 21a may be employed. In the so-called serial type printer, the recording head 21 is mounted on the carriages and ejects ink onto the sheet P while reciprocating in the main scanning direction. In such an embodiment, operation effects equivalent to those in the above embodiments can be obtained.

In the above embodiments, when the absorbing member 13 slides on the ink sweeping surface 16a in order to sweep and remove ink adhered to the ink sweeping surface 16a of the wiper 16, the absorbing member 13 may be moved in the width direction of the sheet P, for example.

In the above embodiments, an abutment surface of the absorbing member 13 against the wiper 16 may have a shape different from a shape that follows the ink sweeping surface 16a obtained when the wiper 16 is made to be in pressure contact with the nozzle forming surface 21a and bends. In such an embodiment, operation effects equivalent to the above items (1), (2), (3), (5), (6), (7), (8) and (9) can be obtained.

In the above embodiments, a space may be formed between the absorbing member 13 and the side face of the recording head 21 as long as ink flown down the nozzle forming surface 21a can be absorbed by the absorbing member 13 arranged at a lower position. In such an embodiment, operation effects equivalent to the above items (1), (2), (3), (4), (5), (7), (8) and (9) can be obtained.

In the above embodiments, a configuration in which a negative pressure is applied to the absorbing member 13 through the suction pump 18 can be eliminated. In such an embodiment, operation effects equivalent to the above items (1) though (6), (8) and (9) can be obtained.

Other materials other than felt such as a rubber sponge and a resin foam material can be also employed as a material of the absorbing member 13 as long as the material can absorb and hold ink.

In the above embodiments, the cleaner mechanism 10, the cap 15 and the wiper 16 may be driven by dedicated driving mechanisms which are different from each other. In such an embodiment, operation effects equivalent to those in the above embodiments can be obtained.

In the above embodiments, the cleaner mechanism 10 may not have the wiper 16. In such an embodiment, operation effects equivalent to the above items (1), (6), (7) and (8) can be obtained.

In the above embodiments, although the liquid ejecting apparatus is embodied as the ink jet printer, a liquid ejecting apparatus which ejects and discharges liquid other than ink may be employed. The invention can be applied to various types of liquid ejecting apparatuses including a liquid ejecting head or the like which discharges a trace amount of liquid droplets. Note that the terminology liquid droplets represents the state of liquid which is discharged from the above liquid ejecting apparatus. For example, a granule form, a teardrop form, and a form that pulls tails in a string-like form therebehind are included as the liquid droplets. The terminology liquid here represents materials which can be ejected by the liquid ejecting apparatus. For example, any materials are included as long as the materials are in a liquid phase. For example, materials in a liquid state having high viscosity or low viscosity or a fluid state such as a sol, gel water, other inorganic solvents, an organic solvent, a solution, a liquid resin or a liquid metal (molten metal) can be included as the liquid. Further, the liquid is not limited to liquid as one state of a material but includes liquids that are dissolved, dispersed, or mixed with particles of a functional material made of a solid material such as pigment particles or metal particles. Typical examples of the liquid are ink described in the above embodiments and liquid crystals. The terminology ink here encompasses various liquid compositions such as common aqueous ink and oil ink, gel ink and hot melt ink. Specific examples of the liquid ejecting apparatus include a liquid ejecting apparatus which ejects liquid in forms of a dispersion or a solution of a material such as an electrode material or a coloring material. The material such as the electrode material or the coloring material are used for manufacturing liquid crystal displays, electroluminescence (EL) displays, surface emitting displays and color filters, for example. Further, the specific examples of the liquid ejecting apparatus include a liquid ejecting apparatus which ejects a bioorganic material used for manufacturing biochips, a liquid ejecting apparatus which ejects liquid used as a precision pipette and serving as a sample, printing equipment and a micro dispenser. Other examples of the liquid ejecting apparatus include a liquid ejecting apparatus which pinpoint-ejects lubricating oil to a precision machine such as a watch or a camera. Further, a liquid ejecting apparatus which ejects a transparent resin solution of an ultraviolet curable resin or the like onto a substrate in order to form a hemispherical microlens (optical lens) used for an optical communication element and the like is included as the liquid ejecting apparatus. In addition, a liquid ejecting apparatus which ejects an acid or alkali etching solution for etching a substrate or the like may be employed as the liquid ejecting apparatus. The invention can be applied to any one type of the liquid ejecting apparatuses.

What is claimed is:

1. A liquid ejecting apparatus comprising:
a liquid ejecting head that has a nozzle forming surface on which nozzles for ejecting liquid are opened and which is provided so as to be inclined;
a cleaning unit that executes a cleaning process of discharging liquid through the nozzles on the nozzle forming surface; and
an absorbing member that is capable of absorbing the liquid and is arranged on a side position of the liquid ejecting head which is lower in the gravity direction in a direction of inclination of the nozzle forming surface.

2. The liquid ejecting apparatus according to claim 1,
wherein the cleaning unit includes a wiper which sweeps the liquid off the nozzle forming surface by making contact with the nozzle forming surface, and
the wiper is capable of abutting against the absorbing member in a state where the liquid is adhered to the wiper.

3. The liquid ejecting apparatus according to claim 2,
wherein the wiper is capable of sliding on the nozzle forming surface from an upper side position to a lower side position in the direction along the nozzle forming surface and abutting against the absorbing member in a state where the wiper is in contact with the nozzle forming surface.

4. The liquid ejecting apparatus according to claim 2,
wherein the wiper is formed with an elastic member having flexibility, and
an abutment surface of the absorbing member against which the wiper abuts has a shape that follows a surface of the wiper at the side of the absorbing member, which is obtained when the wiper slides on the nozzle forming surface and bends.

5. The liquid ejecting apparatus according to claim 2, further comprising a driving mechanism which relatively displaces at least one of the absorbing member and the wiper such that the absorbing member slides along a surface of the wiper to which the liquid is adhered in a state where the absorbing member abuts against the surface of the wiper.

6. The liquid ejecting apparatus according to claim 1,
wherein the absorbing member is arranged to be in contact with the liquid ejecting head so as not to generate a space between the absorbing member and the nozzle forming surface.

7. The liquid ejecting apparatus according to claim 1, further comprising a suction unit which sucks liquid absorbed by the absorbing member by applying a negative pressure to the absorbing member.
